(19) United States
(12) Patent Application Publication
(10) Pub. No.: US 2025/0303509 A1
(43) Pub. Date: Oct. 2, 2025

(54) PROCESSING MACHINE AND ADJUSTMENT METHOD

(71) Applicant: Shibaura Machine Co., Ltd., Tokyo (JP)

(72) Inventor: Takanobu AKIYAMA, Numazu-shi, Shizuoka-ken (JP)

(73) Assignee: Shibaura Machine Co., Ltd., Tokyo (JP)

(21) Appl. No.: 18/861,784

(22) PCT Filed: Apr. 21, 2023
(86) PCT No.: PCT/JP2023/015893

§ 371 Date: Oct. 30, 2024

(30) Foreign Application Priority Data
May 10, 2022 (JP) 2022-077486

(51) Int. Cl. B23Q 5/10

(52) U.S. Cl. CPC B23Q 5/10

(57) ABSTRACT

A processing machine includes a spindle, spindle drive source, moving part, support part, linear motor, brake, and control part. The spindle drive source rotates the spindle. The moving part supports the spindle and the spindle drive source. The support part supports the moving part movably in a first direction. The linear motor makes the moving part and the support part move relative to each other in the first direction. The brake restricts the relative movement of the moving part and the support part in the first direction. The control part operates the brake when adjusting the balance about the spindle.

### TECHNICAL FIELD

The present disclosure relates to a processing machine and an adjustment method.

### BACKGROUND ART

In machine tools and other processing machines, known in the art is the technique of adjusting a balance about a spindle in order to reduce vibration when rotating the spindle (for example, PTL 1 and PTL 2). PTL 1 discloses a technique of adjusting the balance by selectively attaching screws (in other words, balance weights) to the spindle or a member fixed to the spindle at a plurality of positions around a center line (axis of rotation) of the same. The screws are attached manually. PTL 2 discloses a technique of automatically adjusting the balance by a balance adjustment device attached to the spindle. The balance adjustment device has balance weights at a plurality of positions around the axis of rotation and adjusts the balance by individually controlling the positions of the plurality of balance weights in the diameter direction. In any case, the balance adjustment is carried out based on the results of adjustment obtained by rotating the spindle and measuring the vibration about the spindle.

Note that, in the present disclosure, the “adjustment of balance” and other terms will be sometimes used in a broad sense including the measurement of vibration or used in a narrow sense without measurement of vibration. Whether it is used in a broad sense or narrow sense may be suitably interpreted in light of the context.

### CITATION LIST

### Patent Literature

PTL 1: Japanese Patent Publication No. 2004-338034
PTL 2: Japanese Patent Publication No. 2010-038335

### SUMMARY OF INVENTION

### Technical Problems

If a linear motor is employed as a driving part for moving the spindle parallel, sometimes the vibration about the spindle becomes large in the driving direction of the linear motor when rotating the spindle for adjustment of the balance. If the vibration about the spindle becomes large, for example, an alarm is issued by the processing machine, or the rotation of the spindle is compulsorily stopped by the processing machine. As a result, the operator is bothered by the alarm, or the balance cannot be adjusted. Accordingly, a processing machine and adjustment method able to solve such inconvenience has been awaited.

### Solution to Problems

A processing machine according to one aspect of the present disclosure includes a spindle, spindle drive source, moving part, support part, linear motor, brake, and control part. The spindle drive source rotates the spindle. The moving part supports the spindle and the spindle drive source. The support part supports the moving part movably in a first direction. The linear motor makes the moving part and the support part move relative to each other in the first direction. The brake restricts the relative movement of the moving part and the support part in the first direction. The control part operates the brake when adjusting the balance about the spindle.

An adjustment method according to one aspect of the present disclosure is an adjustment method of balance in a processing machine. The processing machine includes a spindle, spindle drive source, moving part, support part, linear motor, and brake. The spindle drive source rotates the spindle. The moving part supports the spindle and the spindle drive source. The support part supports the moving part movably in a first direction. The linear motor makes the moving part and the support part move relative to each other in the first direction. The brake restricts the relative movement of the moving part and the support part in the first direction. The adjustment method includes a detection step, adjustment step, and restriction step. The detection step detects vibration about the spindle in a state where the spindle is rotating. The adjustment step adjusts the balance about the spindle based on the vibration detected by the detection step. The restriction step restricts the relative movement in the first direction of the moving part and the support part by the brake when the detection step is carried out for the adjustment step.

### Advantageous Effect of Invention

According to the above configuration or procedure, vibration when rotating the spindle for the balance adjustment can be reduced. As a result, for example, the likelihood that the operator would be bothered by an alarm or the rotation of the spindle being compulsorily stopped and the adjustment of balance no longer being able to be carried out is reduced.

### BRIEF DESCRIPTION OF DRAWINGS

FIG. 1 is a schematic perspective view showing a principal part of a processing machine according to a first embodiment.

FIG. 2 is a cross-sectional view schematically showing a bearing of a spindle in the processing machine in FIG. 1.

FIG. 3 is a schematic perspective view showing a principal part of a Y-axis driving part in the processing machine in FIG. 1.

FIG. 4 is a schematic front view showing the principal part of the Y-axis driving part in FIG. 3.

FIG. 5 is a block diagram schematically showing the configuration of a signal processing system in the processing machine in FIG. 1.

FIG. 6 is a flow chart showing one example of the procedure of balance adjustment in the processing machine in FIG. 1.

FIG. 7 is a flow chart showing one example of the procedure of processing relating to an adjustment mode in the processing machine in FIG. 1.

FIG. 8 is a block diagram schematically showing the configuration of a signal processing system in a processing machine according to a second embodiment.

FIG. 9A and FIG. 9B are views showing changes along with time in position error at the time of balance adjustment according to comparative examples and examples.

### DESCRIPTION OF EMBODIMENTS

### First Embodiment

First, an outline of a processing machine according to a first embodiment in the present disclosure and its adjustment method will be explained, and then specific examples of the processing machine and adjustment method will be explained.

### (Outline of Processing Machine)

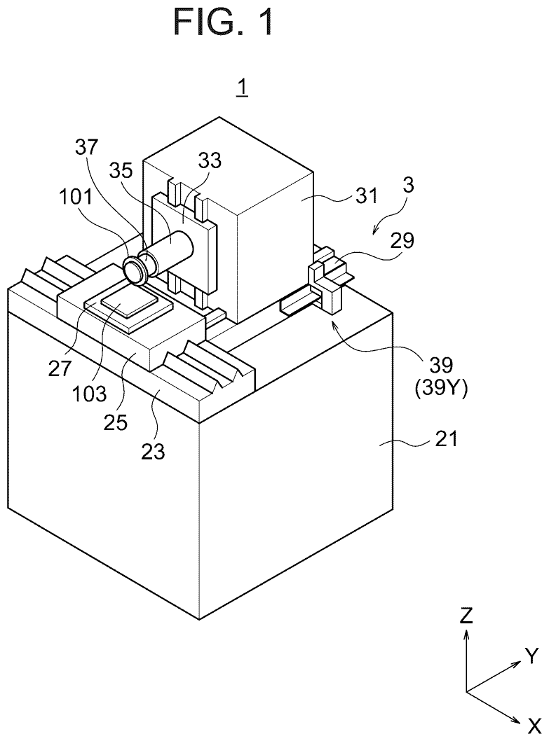

FIG. 1 is a schematic perspective view showing a principal part of a processing machine 1 according to the first embodiment.

The relationships between the orientations of the various members shown and the vertical direction are arbitrary. However, in the following explanation, for convenience, sometimes the explanation will be predicated on the relationships between the orientations of the various members and the vertical direction being as illustrated in the views. To the views, for convenience, an orthogonal coordinate system XYZ will be attached. The Z-direction is, for example, the direction parallel to the vertical direction, and the +Z side is, for example, an upper part.

The processing machine 1, for example, rotates a spindle 37 to which a tool 101 is attached and processes (for example, cuts) a workpiece 103 by the tool 101. At the processing, parallel movements between the tool 101 and the workpiece 103 are also carried out. The processing machine 1 has a configuration including a linear motor as the driving part for moving the spindle 37 in parallel.

In the processing machine 1, in order to reduce the vibration when rotating the spindle 37, balance adjustment is carried out previous to the processing. In the balance adjustment, first, the spindle 37 is rotated and the vibration about the spindle 37 is measured. At this time, as previously explained, the vibration about the spindle 37 becomes large in the driving direction of the linear motor, therefore there sometimes arises the inconvenience that an alarm will be issued by the processing machine 1 or the rotation of the spindle 37 will be compulsorily stopped by the processing machine 1.

Therefore, the processing machine 1 has a brake 39 which restricts the parallel movement of the spindle 37 in the driving direction of the linear motor. By rotating the spindle 37 in a state where the brake 39 is operated, the vibration of the spindle 37 in the driving direction of the linear motor can be reduced. Due to this, the inconveniences described above can be eliminated.

After that, based on the measurement results of vibration, the adjustment of balance about the spindle (narrow sense) is carried out by detachment or position adjustment of the balance weights or the like. As a result, even in a state where the brake is not operated, large vibration as described above no longer occurs. Further, the processing is carried out without problem. At the processing, for example, the brake 39 is not utilized.

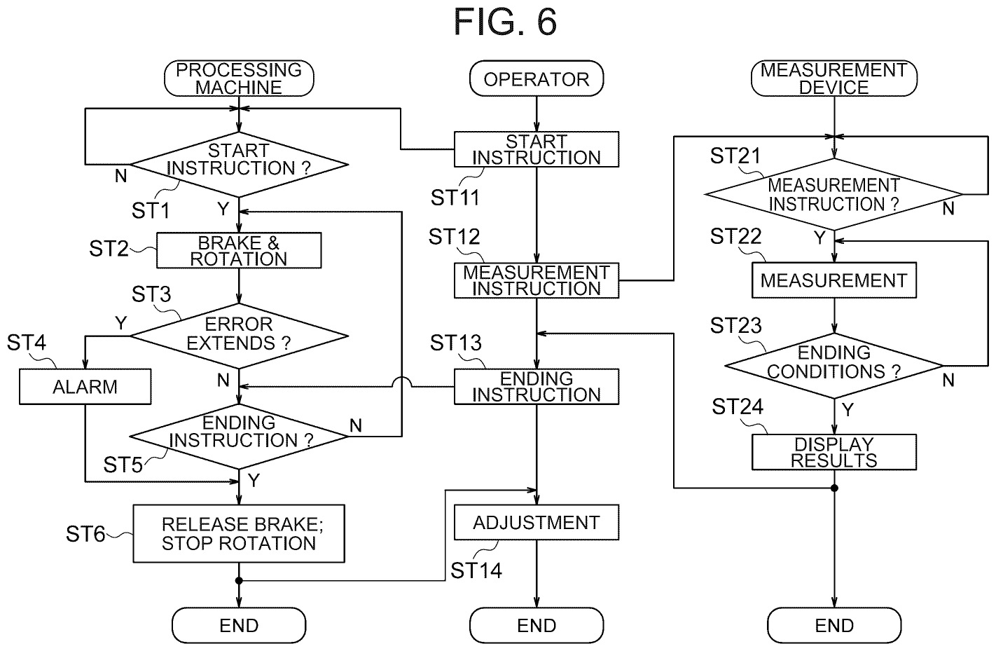

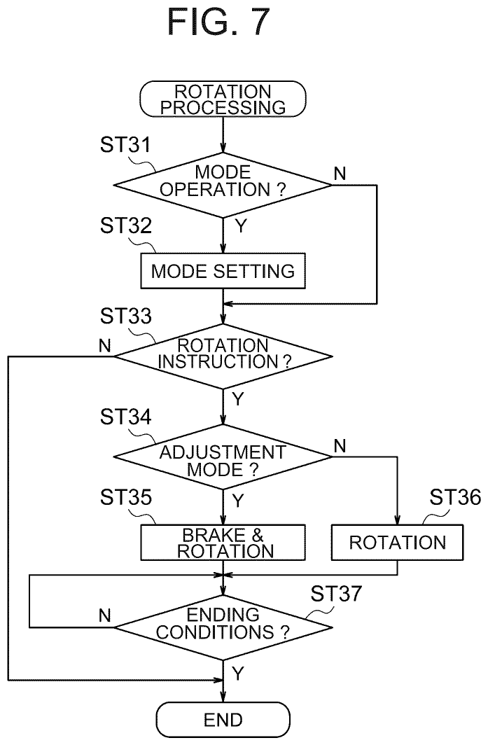

The above explanation covered an outline of the processing machine 1 according to the first embodiment and its adjustment method. Below, specific examples of the processing machine 1 and adjustment method will be explained. In the following description, the explanation will be roughly given in the following order.
1. Tool 101 (FIG. 1)
2. Workpiece 103 (FIG. 1)
3. Processing machine 1 (FIG. 1 to FIG. 5)
4. Procedure of balance adjustment (FIG. 6 and FIG. 7)
5. Summary of first embodiment

### 1. Tool

The tool 101 may be various tools used for various processing. For example, the tool 101 may be made a cutting tool performing cutting, a grinding tool performing grinding, or a polishing tool performing polishing. The cutting tool may be, for example, a rotating tool (milling tool) which rotates by itself and cuts the workpiece 103 (example shown), or may be a turning tool which cuts a rotating workpiece 103. As the rotating tool, for example, there can be mentioned a milling cutter, drill, and reamer. The grinding tool or polishing tool may be one using fixed abrasive grains fixed to the tool or may be one using free abrasive grains contained in a slurry.

As will be understood from the explanation that the tool 101 may be a turning tool as described above, the object which is attached to the spindle 37 need not be the tool 101, but may also be the workpiece 103. However, in the explanation of the present embodiment, without particular notice, sometimes the explanation or expression will be predicated on the tool 101 being attached to the spindle 37 as in the example shown.

The tool 101 illustrated in FIG. 1, in more detail, is a grinding stone performing grinding at its outer peripheral part. From another viewpoint, the tool 101 is a blade having a cutting edge on its outer periphery. The blade is schematically plate-shaped having a circular outer edge (disc shape or ring shape). The blade is utilized for formation of a groove in the workpiece 103 and/or cutting (dividing) the workpiece 103 by rotation about its axis (in the example shown, about the rotation axis parallel to the Y-direction). To the processing machine 1, one blade may be attached (example shown) or a plurality of blades spaced from each other in a direction parallel to the rotation axis may be attached. Note that, in the following explanation, as in the example shown, sometimes the expression will be predicated on the aspect where one blade is attached.

### 2. Workpiece

As will be understood from the above explanation that there may be various types of processing carried out by the tool 101, there may be various workpieces 103 as well. For example, there may be various materials of the workpiece 103. It may be metal, ceramic, resin, wood, chemical wood, or a composite material (for example, carbon fiber-reinforced plastic). The shape and dimensions of the workpiece 103 before processing and/or after processing may be any shape and dimensions. Also the precision of dimensions demanded from the workpiece 103 after processing may be any precision of dimensions. For example, explaining an example of a case where relatively high precision is demanded, the precision (tolerance) may be made 10 μm or less, 1 μm or less, or 100 nm or less.

The workpiece 103 illustrated in FIG. 1 is plate-shaped. The planar shape of the plate-shaped workpiece 103 before processing may be any shape. For example, it may be a box shape (example shown) or circular. As already explained, in an aspect where the tool 101 is a disc-shaped blade having a cutting edge on its outer periphery, the blade, for example, contributes to formation of a groove extending in a direction (X-direction) perpendicular to the rotation axis of the tool 101 in the upper surface (surface on the +Z side) of the plate-shaped workpiece 103 or division of the workpiece 103 in the Y-direction.

### 3. Processing Machine

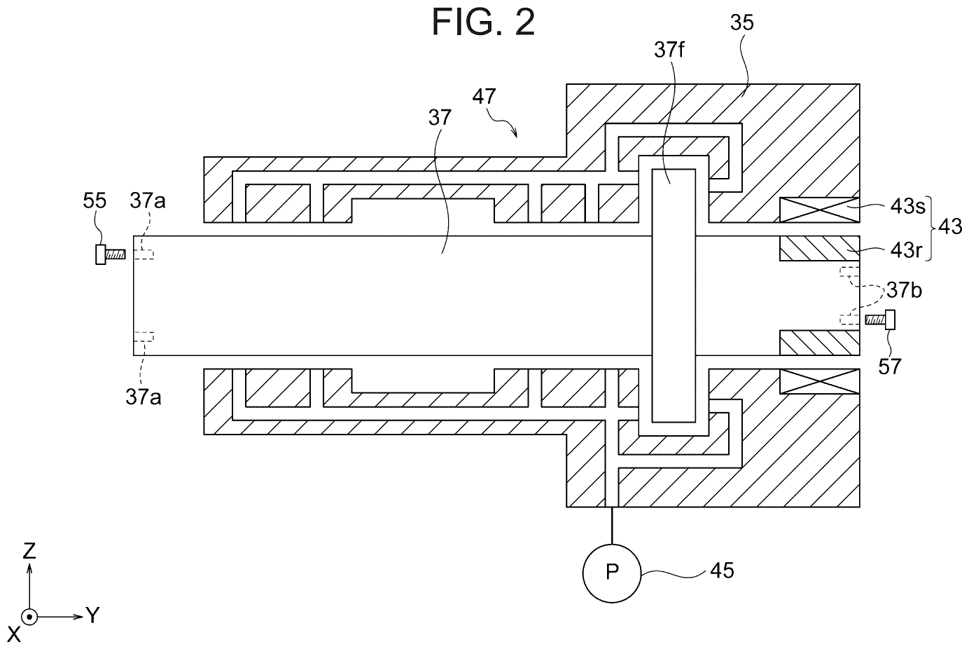

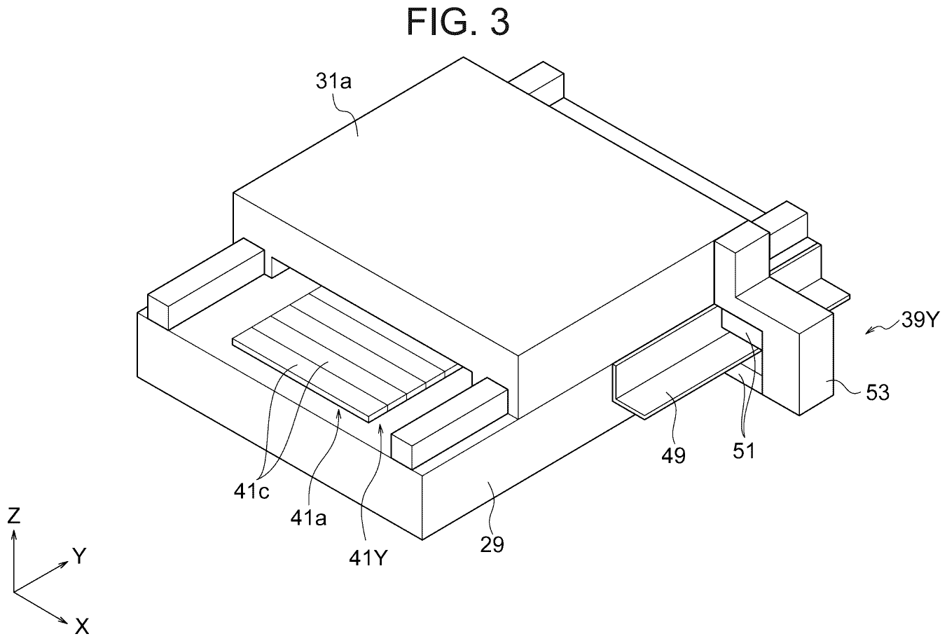

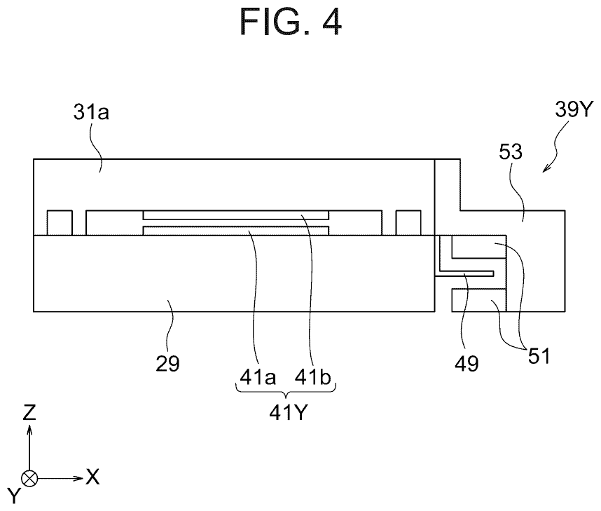

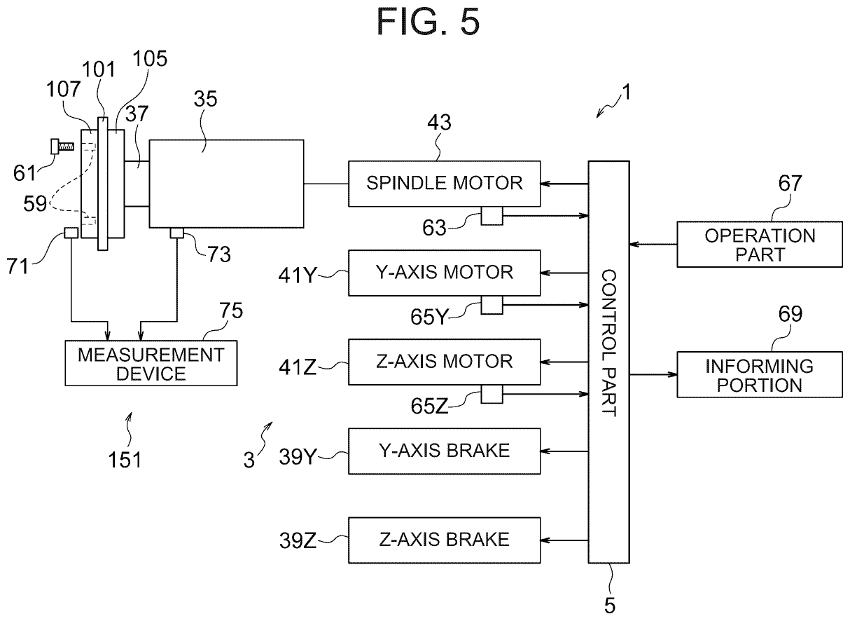

The processing machine 1 has a machine body 3 which includes the spindle 37 and is physically involved in the processing and a control part 5 which controls the machine body 3 (see FIG. 5). In the following explanation, the explanation will be roughly given in the following order.
3.1. Outline of machine body (FIG. 1)
3.2. Machine body in example shown (FIG. 1)
3.3. Example of configuration relating to rotation of spindle (FIG. 2)
3.4. Example of configuration relating to parallel movement of spindle (FIG. 3 and FIG. 4)
3.5. Brake (FIG. 3 and FIG. 4)
3.6. Example of configuration for balance adjustment (FIG. 2 and FIG. 5)
3.7. Control part 5 (FIG. 5)
3.8. Configuration of signal processing system (FIG. 5)

### (3.1. Outline of Machine Body)

The machine body 3 performs support and drive of the tool 101 and workpiece 103. That is, the machine body 3 bears a principal portion of the processing. There may be various aspects of the configuration of the machine body 3. For example, it may have a known configuration excluding the point that the brake 39 is provided.

For example, concerning the machine performing processing, sometimes a machine tool and an industrial robot will be differentiated (the borderline between them is not always clear). In a case where such differentiation is carried out, the machine body 3 (or processing machine 1) may be classified into either group. Note that, in the explanation of the present embodiment, the aspect where the machine is generally classified as a machine tool will be taken as an example.

Further, for example, as will be understood from the already given explanation of the tool 101, the processing aimed at by the machine body 3 (or processing machine 1) may be various ones such as cutting, grinding, and/or polishing. Further, the machine body 3 performing the cutting etc. may be one rotating the tool 101 or may be one rotating the workpiece 103.

The machine body 3 may be or may not be a multi-tasking machine tool. The machine body 3 may be one driving one tool 101 (example shown) or may be a multiaxial or multi-head one which simultaneously drives a plurality of tools 101. The machine body 3 (processing machine 1) rotating the tool 101 (rotating tool) may be, for example, a milling machine, drilling machine, boring machine, or machining center.

The machine body 3 makes the tool 101 and the workpiece 103 move relative to each other, for example, in each of the X-axis, Y-axis, and Z-axis perpendicular to each other. The machine body 3, in addition to the above three axes, may be one able to make the tool 101 and the workpiece 103 relatively move along another axis. For example, the machine body 3 (processing machine 1) may be one able to perform rotation about at least one axis which is parallel to any of the above three axes (for example, in a 5-axis machining center) as well. The relative movements in each axis of the tool 101 and the workpiece 103, as will be understood from a known machine tool, may be realized by movement of the tool 101 or may be realized by movement of the workpiece 103.

In an aspect where the tool 101 is a rotating tool, the relative relationships among the orientation of the spindle 37, the orientation of the table 25, the vertical direction, and the movement direction of the spindle 37 for which the brake 39 is utilized (Y-direction and Z-direction in the example shown, below, sometimes referred to as the “first direction”) are arbitrary. In the same way, in an aspect where the tool 101 is a turning tool, the relative relationships among the orientation of the spindle 37, the orientation of the tool post, the vertical direction, and the first direction are arbitrary.

For example, the spindle 37 (its rotation axis) may be parallel with (example shown) or may cross (for example, be perpendicular with) the upper surface of the table 25. Further, the first direction may cross (for example, be perpendicular with, for example, Z-direction in the example shown) with respect to the spindle 37 or may be parallel to the same (for example, Y-direction in the example shown). Further, the first direction may cross (for example, be perpendicular with) the upper surface of the table 25 (for example, the Z-direction in the example shown) or may be parallel to the same (for example, Y-direction in the example shown).

### (3.2. Machine Body in Example Shown)

FIG. 1, as the machine body 3, illustrates a slicer able to perform cutting by rotating the disc-shaped tool 101 having a cutting edge on its outer periphery.

Specifically, for example, the machine body 3 illustrated in FIG. 1 has the following components as components supporting the workpiece 103: a base 21 arranged on a floor surface or the like in a factory, an X-axis bed 23 fixed onto the base 21, a table 25 which is supported upon the X-axis bed 23 and is able to move in the X-direction (horizontal direction), and a chuck 27 which is fixed onto the table 25 and holds the workpiece 103 detachably. Although not particularly shown, the machine body 3 may be configured so as to be able to rotate the table 25 about an axis parallel to the Z-axis as well.

Further, for example, the machine body 3 illustrated in FIG. 1 has the following components as components supporting and driving the tool 101: the above base 21, a Y-axis bed 29 fixed onto the base 21, a Y-axis moving part 31 which is supported upon the Y-axis bed 29 and is movable in the Y-direction (horizontal direction), a Z-axis moving part 33 which is supported upon the Y-axis moving part 31 and is movable in the Z-direction (vertical direction), a spindle head 35 (not including the spindle 37) which is fixed to the Z-axis moving part 33, and a spindle 37 which is supported by the spindle head 35 rotatably about a rotation axis parallel to the Y-direction and detachably holds the tool 101.

A driving force from a not shown drive source (for example, electric motor) is transmitted to the table 25, the table 25 moves in the X-direction, and the workpiece 103 supported upon the table 25 relatively moves in the X-direction relative to the tool 101. By the driving force from the predetermined drive source (for example, Y-axis motor 41Y shown in FIG. 5 which will be explained later) being transmitted to the Y-axis moving part 31 to move the Y-axis moving part 31 in the Y-direction, the tool 101 supported by the Y-axis moving part 31 relatively moves in the Y-direction relative to the workpiece 103. By the driving force from the predetermined drive source (for example, Z-axis motor 41Z shown in FIG. 5) being transmitted to the Z-axis moving part 33 to move the Z-axis moving part 33 in the Z-direction, the tool 101 supported by the Z-axis moving part 33 relatively moves in the Z-direction relative to the workpiece 103. By the driving force from the predetermined drive source (for example, spindle motor 43 shown in FIG. 5) being transmitted to the spindle 37 to rotate the spindle 37 about the axis, the tool 101 held by the spindle 37 rotates about the axis.

FIG. 1 is a schematic view. The shape of each member (21, 23, 25, 27, 29, 31, 33, 35, and 37) is just a schematic one. The shapes of actual members may deviate from the shown shapes as well. Further, the material of each member is arbitrary. Further, the guide (notation is omitted) which guides the moving part (25, 31, or 33) moving parallel with respect to the support part (23, 29, or 31) is only schematically shown and may be separated from the shown shape etc.

The guide which guides the moving part (25, 31, or 33) which moves parallel with respect to the support part (23, 29, or 31) (from another viewpoint, restricts movement in a direction other than the parallel direction) may be made a suitable one. For example, the guide may be a sliding guide where the support part and moving part slide, may be a rolling guide where a rolling body rolls between the support part and the moving part, may be a hydrostatic guide which interposes air or oil between the support part and the moving part, or may be a combination of two or more of them. In the same way, the bearing of the spindle 37 may be made a sliding bearing, rolling bearing, hydrostatic bearing, or a combination of two or more of them.

The drive source relating to the parallel movement is, for example, an electric motor. This electric motor may be a rotary one or may be a linear motor. In the present embodiment, however, at least one of the one or more drive sources making the spindle 37 move parallel is made a linear motor. The rotational motion of the rotary electric motor may be converted to linear motion by a suitable mechanism such as screw mechanism (for example, ball-screw mechanism). Further, the drive source relating to the parallel movement may be made a hydraulic type (including oil pressure type, same is true for the following explanation) or pneumatic circuit type (including air pressure type, same is true for the following explanation).

The drive source relating to the rotation of the spindle 37 is, for example, a rotary electric motor. However, the drive source relating to the rotation of the spindle 37 may be made a hydraulic type or pneumatic type. The rotation of the rotary electric motor may be directly transmitted to the spindle 37 or may be transmitted to the spindle 37 through a clutch and/or speed conversion mechanism.

The specific configurations of various electric motors relating to the parallel movement or the rotation of the spindle 37 may be made various ones. The electric motor may be a DC electric motor or may be an AC electric motor. The AC electric motor may be a synchronous motor or may be an induction motor.

The chuck 27 is, for example, configured by a vacuum chuck or electrostatic chuck and is attached to the table 25 by a machine vice (not shown) or another suitable instrument. Note that, the chuck 27 may be configured integrally with the table 25 unlike the above explanation. Further, the chuck 27 need not be provided, and the workpiece 103 may be fixed to the table 25 by a suitable jig (for example, machine vice) which is different from the chuck 27. Note that, unlike the explanation of the present embodiment, a combination of the table 25 and the chuck 27 may be grasped as the table as well.

The spindle 37 may hold the tool 101 by a mechanism provided in itself (for example, clamp mechanism), or the tool 101 may be attached by an instrument including a screw etc. The blade (tool 101), for example, may be fixed to the spindle 37 by a member (not shown) having a shaft portion which is inserted through a hole formed at the center of the blade, flanges 105 and 107 superposed on the blade in the axial direction of the spindle 37 (see FIG. 5), and a screw (not shown) which is inserted through these members and is screwed with the spindle 37. In such an aspect, the blade may be grasped as the tool 101, or the entireties of the blade and the instrument for attaching the blade to the spindle 37 may be grasped as the tool 101.

### (3.3. Example of Configuration Relating to Rotation of Spindle)

FIG. 2 is a cross-sectional view showing an example of the configuration relating to the rotation of the spindle 37.

As already explained, the bearing of the spindle 37 and the drive source of the spindle 37 may be configured in any way. FIG. 2 illustrates a hydrostatic bearing as the bearing of the spindle 37 and illustrates a rotary electric motor as the drive source of the spindle 37. Specifically, this is as follows.

A clearance is configured between the outer surface of the spindle 37 and the inner surface of the spindle head 35. To the clearance, a fluid is supplied with a predetermined pressure by a pump 45 or the like. The fluid may be gas (for example, air) or may be liquid (for example, oil or water). According to such a configuration, a bearing 47 is configured as a hydrostatic bearing. Note that, a static pressure bearing where the fluid is air is sometimes referred to as an “air bearing”. The bearing 47 may be grasped as having the spindle head 35 or a surface of the spindle head 35 facing the spindle 37 across the clearance. Further, in addition to this, it may be grasped as having a pump 45 as well. In the case where the fluid is gas, a compressor is made one aspect of the pump.

The bearing 47 in the example shown, in more detail, has a function of a radial bearing of supporting the spindle 37 in the diameter direction and a function of a thrust bearing of supporting the spindle 37 in the axial direction. The radial bearing is realized by the fluid interposed between the outer circumferential surface around the axis of the spindle 37 and the inner circumferential surface of the spindle head 35 facing the outer circumferential surface. The thrust bearing is realized by the fluid interposed between the two surfaces (front and back) in the axial direction of the flange portion 37f provided in the spindle 37 and two surfaces of the spindle head 35 respectively facing the former two surfaces.

The spindle motor 43 used as the rotary electric motor which rotates the spindle 37 is, for example, configured by a built-in motor. In other words, no attenuation mechanism etc. is interposed between the spindle 37 and the spindle motor 43. Specifically, for example, the spindle motor 43 has a rotor 43r fixed to the spindle 37 and a stator 43s fixed to the spindle head 35. The rotor 43r configures one of a field magnet and an armature. The stator 43s configures the other of the field magnet and the armature. Note that, the spindle motor 43 may be provided at a suitable position with respect to the spindle 37 in its shaft direction.

### (3.4. Example of Configuration Relating to Parallel Movement of Spindle)

FIG. 3 is a perspective view showing one example of the configuration relating to the movement in the Y-direction of the spindle 37 (Y-axis moving part 31). FIG. 4 is a front view of the configuration shown in FIG. 3.

In FIG. 3 and FIG. 4, in the Y-axis moving part 31, only a lower portion 31a is shown. Note that, the part in the lower part in the Y-axis moving part 31 which is cut and shown for convenience for facilitating the illustration is the lower portion 31a. The shape of the lower portion 31a and the shape of the member which is assembled in order to configure the Y-axis moving part 31 do not always coincide.

The guide which guides the Y-axis moving part 31 in the Y-direction may be configured in any way as already explained. FIG. 3 and FIG. 4 illustrate a guide having a projecting rail although notation is not particularly attached. As will be understood from the already given explanation, between the rail and the Y-axis moving part 31, rolling bodies (for example, balls) may be interposed, a fluid may be interposed, or nothing may be interposed.

The drive source which moves the Y-axis moving part 31 in the Y-direction may be configured in any way as already explained. FIG. 3 and FIG. 4 illustrate a linear motor (Y-axis motor 41Y) as the drive source. For example, the Y-axis motor 41Y has a magnet array 41a configured by a plurality of magnets 41c arranged in the Y-direction on the upper surface of the Y-axis bed 29 and a suitable number of coils 41b (FIG. 4) which are fixed to the lower surface of the Y-axis moving part 31 and face the magnet array 41a. Further, by the AC power being supplied to the coils 41b, the magnet array 41a and the coils 41b generate a driving force in the Y-direction. In turn, the Y-axis moving part 31 moves in the Y-direction with respect to the Y-axis bed 29.

Here, a drive source which moves the Y-axis moving part 31 was taken as an example. However, the above explanation may be suitably invoked even in a case where the drive source which moves the Z-axis moving part 33 is a linear motor. Note that, in the explanation of the present embodiment, sometimes the explanation and expression will be predicated on the drive source which moves the Z-axis moving part 33 also being a linear motor (as shown in FIG. 5 which will be explained later, it will be sometimes referred to as the Z-axis motor 41Z) in the same way as the Y-axis motor 41Y.

### (3.5. Brake)

The brake 39 may have various aspects. For example, the brake 39 may be a friction brake which utilizes frictional resistance, may be a fluid brake which utilizes motion resistance of a fluid, or an electric brake which converts kinetic energy to electric energy. The brake 39 only need have a function of restricting movement of the moving part (31 or 33) in a stopped state. In other words, it need not have a function of decelerating the moving part in a moving state (naturally, it may also have this function). Accordingly, the brake 39, unlike a usual brake, may also be configured so as to restrict movement by abutting against (engaging with) the moving part in the movement direction of the moving part.

FIG. 3 and FIG. 4 are views showing an example of the configuration of the Y-axis brake 39Y (one example of the brake 39) which restricts the movement in the Y-direction of the spindle 37 (Y-axis moving part 31) as well.

The Y-axis brake 39Y is configured so as to utilize frictional resistance. Specifically, the Y-axis brake 39Y has a plate 49, a pair of pads 51 facing each other while sandwiching a part of the plate 49 between them, and a driving part 53 which makes the pair of pads 51 abut against or separate from the plate 49.

The plate 49 is fixed to one of the Y-axis bed 29 and the Y-axis moving part 31 (Y-axis bed 29 in the example shown). The driving part 53 is fixed to the other of the Y-axis bed 29 and the Y-axis moving part 31 (Y-axis moving part 31 in the example shown). The pair of pads 51 is supported by the driving part 53. The plate 49 has a portion (abutted portion) which extends parallel in the Y-direction. Further, the brake operates by the pair of pads 51 abutting against the abutted portion in the direction (Z-direction in the example shown) perpendicular to the Y-direction.

Note that, the pads 51 can be expressed as a first member which is supported by the moving part (Y-axis moving part 31) so as to be immovable in the first direction (Y-direction) with respect to the moving part. Further, the plate 49 can be expressed as a second member which is supported by the support part (Y-axis bed 29) so as to be immovable in the first direction (Y-direction) with respect to the support part.

The plate 49, for example, has the same length as the movable distance of the Y-axis moving part 31. Accordingly, the Y-axis brake 39Y is able to restrict the movement of the Y-axis moving part 31 in a state where the Y-axis moving part 31 is located at any position. However, the length of the plate 49 may be shorter than the above distance as well. For example, the plate 49 may have a length long enough to restrict the movement of the Y-axis moving part 31 only at the time when the Y-axis moving part 31 is located at the predetermined position.

The plate 49, for example, has a shape enabling the pair of pads 51 to abut against its two surfaces. In the example shown, the plate 49 has a fin-shaped portion having a width in the X-direction, having two surfaces exposed in the Z-direction (front and back of the plate shape), and extending in the Y-direction. The fin-shaped portion is, for example, a schematically rectangular flat plate shape. However, the portion at which the pair of pads 51 abut against the two surfaces may be provided in an orientation and shape different from those described above. For example, this portion may have a width in the Z-direction, and the two surfaces in the X-direction (front and back of the plate shape) may be exposed.

The Y-axis brake 39Y may have only one pad 51 as well. In this case, the plate 49 does not have to have a portion having two surfaces exposed. Accordingly, for example, the plate 49 may have only a portion superposed on the side surface of the Y-axis bed 29 as well. Further, the pad 51 may be pushed against the Y-axis bed 29 in the X-direction as well.

There may be various driving methods of the driving part 53. For example, it may be a hydraulic type, may be a pneumatic type, or may be an electric type. Also, the specific structure may be any structure. For example, although not particularly shown, the driving part 53 may have a pneumatic type cylinder. Further, the pair of pads 51 may be made to abut against and/or separate from the plate 49 by gas being supplied to the cylinder to drive the cylinder.

A transmission mechanism having a suitable configuration may be interposed between the drive source (for example, a pneumatic type cylinder) and the pair of pads 51. The transmission mechanism may contribute to the power generated by the drive source being distributed to the pair of pads 51 or to the power driving the pads 51 being made larger. Further, one of the abutment and the separation may be realized by a restoring force of a spring. The power of the drive source such as a pneumatic type cylinder may be utilized for only the other of the abutment and the separation.

In a case where the drive source is a hydraulic type or pneumatic type cylinder, for example, the Y-axis brake 39Y may be controlled by control of a not shown valve which controls supply etc. of the liquid or gas to these cylinders. The valve may be suitable type one such as an electromagnetic valve. Note that, in the following explanation, for convenience, existence of such a valve will be sometimes ignored in the expression. For example, sometimes it will be expressed as “the control part 5 controls the brake 39”. Further, unlike the above description, the valve may be grasped so as to be included in the brake 39 as well.

The configuration of the Y-axis brake 39Y shown in FIG. 3 and FIG. 4 may be applied to a brake in another direction (for example, the Z-axis brake 39Z shown in FIG. 5 which will be explained later). For example, although not particularly shown, the Z-axis brake 39Z may have a plate 49 which is fixed to one of the Y-axis moving part 31 (support part) and the Z-axis moving part 33 (moving part), a driving part 53 which is fixed to the other of the Y-axis moving part 31 and the Z-axis moving part 33, and a pair of pads 51 supported by the driving part 53. The plate 49 may have a portion (abutted portion) extending in the Z-direction. Further, by the pair of pads 51 abutting against the abutted portion, the relative movements in the Z-direction of the Y-axis moving part 31 and the Z-axis moving part 33 may be restricted.

When referring to “the brake restricts the relative movements of the moving part (for example, Y-axis moving part 31) and the support part (for example, Y-axis bed 29)”, the brake may directly restrict the relative movements of the two supported by the moving part and the support part as in the example shown or may indirectly restrict the relative movements of the two supported by other portions. For example, the relative movements in the Y-direction of the Y-axis moving part 31 and the Y-axis bed 29 may be restricted as well by the pad 51 supported by the Z-axis moving part 33 and the plate 49 supported by the Y-axis bed 29 abutting against each other.

### (3.6. Example of Configuration for Balance Adjustment)

There may be various configurations concerning the adjustment of balance about the spindle excluding the measurement of vibration about the spindle (that is adjustment in a narrow sense). For example, it may be made a known configuration. An example will be explained below.

As shown in FIG. 2, the front end portion of the spindle 37 (end portion on the side where the tool 101 is attached) may be provided with female screw portions 37a at a plurality of positions around the axial center of the spindle 37. Further, the balance may be adjusted by male screws 55 being selectively screwed with respect to the plurality of female screw portions 37a. The female screw portions 37a may be positioned in the front end surface of the spindle 37 (example shown) or may be positioned at the outer circumferential surface of the front end portion of the spindle 37.

Further, as shown in the same view, the rear end portion of the spindle 37 may be provided with female screw portions 37b at a plurality of positions around the axial center of the spindle 37. Further, the balance may be adjusted by the male screws 57 being selectively screwed with respect to the plurality of female screw portions 37b. The female screw portions 37b may be positioned in the rear end surface of the spindle 37 (example shown) or may be positioned in the outer circumferential surface of the rear end portion of the spindle 37.

As shown in FIG. 5, the tool 101, or an instrument (flange 105 or 107) for attaching the tool 101 to the spindle 37, may be provided with female screw portions 59 at a plurality of positions around the axial center of the spindle 37. Further, the balance may be adjusted by the male screws 61 being selectively screwed with respect to the plurality of female screw portions 59. In the example shown, the female screw portions 59 are provided in the flange 107 positioned on the front end side relative to the tool 101. In this case, the female screw portions 59 may be positioned in the front surface of the flange 107 (the surface on the side opposite to the tool 101, example shown), or may be positioned in the outer circumferential surface of the flange 107.

Other than the above description, although not particularly shown, a balance ring may be utilized as well. Further, in a case where the tool 101 is a grinding stone utilizing fixed abrasive grains as in the example shown, the balance may be adjusted by cutting the tool 101 as well. In this case, the processing machine 1 may have a configuration (not shown) for truing.

As will be understood from the above explanation and the configuration relating to the spindle 37 in FIG. 2, not only the spindle 37, but also the rotor 43r of the spindle motor 43 and the tool 101 are related to the balance. Accordingly, in the explanation of the present disclosure, in place of the term of the “balance of the spindle 37”, sometimes use will be made of the term of the “balance about the spindle 37”. The “balance” designates the balance of the entireties of the spindle 37 and the members which rotate together with the spindle 37. However, for convenience, unless it is particularly explained or contradictions arise, the term of the “balance of the spindle 37” and the term of the “balance about the spindle 37” may be replaced by each other.

### (3.7. Control Part)

The control part 5 shown in FIG. 5 may be, for example, configured including a computer. The computer, for example, although not particularly shown, is configured including a CPU (central processing unit), ROM (read only memory), RAM (random access memory), and external storage device. By the CPU running the program stored in the ROM and/or external storage device, various types of function parts performing control etc. are constructed. Note that, the control part 5 may include a logical circuit which performs only constant processing as well.

The control part 5 is in concept the control part for the entirety of the processing machine 1. The control part 5 may be centralized at one portion in terms of hardware or may be provided dispersed to a plurality of portions.

### (3.8. Configuration of Signal Processing System)

FIG. 5 is a block diagram showing the configuration of the signal processing system of the processing machine 1. In this view, the configuration relating to the balance adjustment of the spindle 37 is extracted and shown. Accordingly, for example, illustration of the drive source for moving the table 25 is omitted.

In this view, in addition to the processing machine 1, a measurement system 151 for measuring the vibration about the spindle 37 is shown. In the explanation of the present embodiment, the measurement system 151 will be explained as a device different from the processing machine 1. However, the processing machine 1 may be defined including the measurement system 151 as well.

The processing machine 1, as explained hitherto or as shown in FIG. 5, has the machine body 3 directly related to the processing and the control part 5 which controls the machine body 3. The machine body 3 has the spindle 37, spindle head 35, spindle motor 43, Y-axis motor 41Y, Z-axis motor 41Z, Y-axis brake 39Y, and Z-axis brake 39Z.

Further, the processing machine 1, for example, has a rotation sensor 63 which detects the rotation speed (rotational frequency) of the spindle motor 43, a Y-axis position sensor 65Y which detects the position of the Y-axis motor 41Y (position of the slider with respect to the stator), and a Z-axis position sensor 65Z which detects the position of the Z-axis motor 41Z. The configurations of the various types of sensors may be various ones. For example, the rotation sensor 63 may be made a rotary encoder or resolver. The Y-axis position sensor 65Y and Z-axis position sensor 65Z may be, for example, linear encoders or laser distance meters.

The control part 5 may perform feedback control of the rotation speed of the spindle motor 43 based on the rotation speed detected by the rotation sensor 63. The control part 5 may perform feedback control of the position of the Y-axis motor 41Y based on the position detected by the Y-axis position sensor 65Y. The control part 5 may perform feedback control of the position of the Z-axis motor 41Z based on the position detected by the Z-axis position sensor 65Z.

In FIG. 5, for convenience, an aspect of a so-called semi-closed loop where the rotation speed or position of the motor is utilized for feedback is illustrated. However, in the configuration illustrated in FIG. 1 to FIG. 4, the spindle motor 43 is a built-in motor fixed to the spindle head 35 and spindle 37, the Y-axis motor 41Y is a linear motor fixed to the Y-axis bed 29 and Y-axis moving part 31, and the Z-axis motor 41Z is a linear motor fixed to the Y-axis moving part 31 and Z-axis moving part 33. In other words, between the electric motor and the drive object, no gear mechanism or another mechanism which causes position error is interposed. Accordingly, FIG. 5 may be grasped as showing a so-called full closed loop as well which performs feedback control by detecting the rotation speed or position of the drive object.

In a configuration different from the configuration illustrated in FIG. 1 to FIG. 4, in place of or in addition to the semi-closed loop, feedback control of a so-called full closed loop may be carried out as well. In the configuration illustrated in FIG. 1 to FIG. 4 and the configuration different from that configuration, for example, the position in Y-direction of the spindle 37 may be detected without detection of the position in the Y-direction of the Y-axis moving part 31. That is, feedback control of a stricter full closed loop may be carried out as well. Further, feedback control need not be carried out concerning the drive of any axis (including the rotation of the spindle 37). That is, so-called open control may be carried out.

Note that, as will be understood from the above various aspects relating to the control, as the sensor, a sensor which directly detects the rotation or position of the detection target and a sensor which indirectly detects the same may be considered. However, in the present disclosure, for convenience, unless particularly explained, the two will not be differentiated. For example, when referring to the “position sensor which detects the position in the Y-direction of the spindle 37”, this sensor may be one directly detecting the position of the spindle 37 relative to an immovable portion (for example, the base 21 or Y-axis bed 29), may be one indirectly detecting the position of the spindle 37 by directly detecting the position of the Y-axis moving part 31 relative to the immovable portion, or may be one indirectly detecting the position of the spindle 37 by directly detecting the position of the Y-axis motor 41Y (position of the slider with respect to the stator). Further, relating to the above description, for example, when referring to the “position error” of the spindle 37 based on the detection value of the position sensor, that position error may be one based on the detection value of a sensor which directly detects the position of the spindle 37 or may be one detected by a sensor (for example, Y-axis position sensor 65Y) which indirectly detects the position of the spindle 37.

The processing machine 1 has an operation part 67 which accepts operations by an operator and an informing portion 69 which performs notifications to the operator. These configurations may be various configurations. For example, they may be known configurations. For example, the operation part 67 may be configured including a touch panel and mechanical switch. The informing portion 69 may be one visually showing the information and/or one audioally indicating the information. As the former, for example, there can be mentioned a display (may be used also as the touch panel) which displays any image, a display which performs segment display, and a lamp which displays information through its illumination status. As the latter, there can be mentioned a speaker. For example, based on the information input from the operation part 67 and/or information from the machine body 3 (for example, various sensors), the control part 5 may control the machine body 3 or may control the informing portion 69 so as to provide predetermined information.

There may be various configurations of the measurement system 151. For example, it may be made a known configuration. For example, the measurement system 151 has a rotation sensor 71 which detects the rotation speed of the spindle 37, a vibration sensor 73 which measures the vibration about the spindle 37, and a measurement device 75 receiving as input the signals from these sensors.

The rotation sensor 71, for example, detects passing of a detected portion (not shown) which is attached to the tool 101 or the instrument (flange 107 etc.) for attachment of the tool 101. The detected portion is at a position distant from the center of rotation. That is, the rotation sensor 71 is a rotary encoder. The detected portion may be detachable with respect to the tool 101 or instrument (flange 107). Note that, the rotation sensor 71 need not be provided either.

The vibration sensor 73 is attached at a suitable position (outer circumferential surface of the spindle head 35 in the example shown) at which vibration appears along with the rotation of the spindle 37 and detects displacement, velocity, and/or degree of acceleration. The vibration sensor 73 may be detachable with respect to the processing machine 1 by a magnet or screws etc. Note that, the displacement, velocity, and degree of acceleration may be converted to each other by differentiation or integration. Therefore, for convenience, sometimes they will not be particularly differentiated in the explanation of the embodiment. The same is true for the rotation sensor and position sensor.

The measurement device 75, although not particularly shown, is configured including a computer, operation part, and informing portion. For these components, the explanation of the control part 5, operation part 67, and informing portion 69 may be suitably invoked. The measurement device 75, for example, displays information (information of the detection value itself and/or information obtained by processing the information of the detection value itself) based on the detection value of the vibration sensor 73 (and the detection value of the rotation sensor 71 according to need). Due to this, the operator can study guidelines for the work of adjusting the balance (for example, to which positions are the male screws 55, 57 and/or 61 attached).

Note that, in the example shown, as will be understood from the vibration sensor 73 being attached to the spindle head 35, the vibration of the measurement target need not be only the vibration of the spindle 37 or a member (for example, tool 101) fixed to the spindle 37, but also the vibration of the member to which the vibration from the spindle 37 is transmitted. Accordingly, in the explanation of the present disclosure, in place of the term of the “vibration of the spindle 37”, sometimes use will be made of the term of the “vibration about the spindle 37”. It may be reasonably judged in the light of technical common sense whether it may be vibration about the spindle 37 (whether it is vibration able to contribute to the balance adjustment). For convenience, unless it is particularly explained or a contradiction occurs, the term of the “vibration of the spindle 37” and the term of the “vibration about the spindle 37” may be substituted with each other.

### 4. Procedure of Balance Adjustment

FIG. 6 is a flow chart showing one example of the procedure of balance adjustment.

In this chart, steps ST1 to ST6 on the left side in the chart show the operation of the processing machine 1 (from another viewpoint, the control by the control part 5). Steps ST11 to ST14 at the center in the chart show the work of the operator. Steps ST21 to ST24 on the right side in the chart show the operation of the measurement device 75.

At step ST11, the operator instructs start of the rotation of the spindle 37 for measurement of the vibration about the spindle 37 to the processing machine 1 by operation with respect to the operation part 67 of the processing machine 1.

At step ST1, the control part 5 judges whether the instruction of step ST11 described above is issued. Further, it stands by (repeats step ST1) at the time of negative judgment, while proceeds to step ST2 at the time of positive judgment

At step ST2, the control part 5 operates the brake 39 (for example, Y-axis brake 39Y and Z-axis brake 39Z) and restricts the parallel movement of the spindle 37. Further, the control part 5 rotates the spindle motor 43. The restriction of parallel movement is, for example, started before the start of rotation of the spindle motor 43. However, before the vibration of the spindle 37 becomes large, there is no problem even if the start of restriction is somewhat late from the start of rotation.

The rotation speed of the spindle motor 43 is, for example, made a predetermined target rotation speed (that is, is made constant). This target rotation speed may be set by operation with respect to the operation part 67 at step ST11. The position of the spindle 37 when the parallel movement is restricted may be, for example, made the position at the time when step ST11 is carried out (from another viewpoint, the time when the positive judgment of step ST1 is carried out). Otherwise, after step ST11 and before step ST2, the processing machine 1 may move the spindle 37 to a predetermined target position as well. The target position may be set by the operation with respect to the operation part 67 at step ST11 or may be set by the operator or manufacturer before that.

After step ST11, the operator judges whether the rotation speed displayed in the informing portion 69 or the informing portion in the measurement device 75 reaches the target rotation speed. Further, when judging arrival, the operator instructs the start of measurement of vibration to the measurement device 75 through the operation part of the measurement device 75 (step ST12).

At step ST21, the measurement device 75 judges whether the instruction of step ST12 described above is issued. Further, it stands by (repeats step ST21) at the time of negative judgment, while proceeds to step ST22 at the time of positive judgment.

At step ST22, the measurement device 75 acquires the information of the detection value (information of a physical quantity (displacement etc.) relating to the vibration of the spindle 37) from the vibration sensor 73. The cycle of acquiring the information of the detection value (sampling period) may be any cycle.

At step ST23, the measurement device 75 judges whether a condition for ending the measurement is satisfied. Further, the measurement device 75 continues the measurement (returns to step ST22) at the time of negative judgment, while proceeds to step ST24 at the time of positive judgment. The condition for ending the measurement may be, for example, that a predetermined time has passed from the start of measurement or that an operation instructing ending of the measurement is carried out by the operator.

At step ST24, the measurement device 75 displays the measurement results in the informing portion. The displayed information may be time sequence data of the detection values themselves or the result of analysis based on the detection values. The result of analysis may be, for example, the content indicating a position to which the male screw 55, 57, or 61 is to be attached.

After step ST12, the operator judges whether the measurement device 75 ends the measurement or instructs ending of measurement to the measurement device 75, for example, based on the information displayed in the informing portion of the measurement device 75. Further, when the measurement by the measurement device 75 ends, the operator instructs ending of the rotation of the spindle 37 for measurement to the processing machine 1 by operation with respect to the operation part 67 (step ST13).

At step ST3, the control part 5 of the processing machine 1 judges whether the position error exceeds a predetermined threshold value (in other words, whether it is too large) based on the detection value of the position sensor (for example, Y-axis position sensor 65 and/or Z-axis position sensor 65Z). Further, the control part 5 proceeds to step ST4 at the time of positive judgment, while proceeds to step ST5 at the time of negative judgment.

At step ST4, the control part 5 controls the informing portion 69 so as to inform the operator that the position error exceeds the threshold value. That is, the processing machine 1 issues an alarm. As will be understood from the explanation of the configuration of the informing portion 69, the alarm may be a visual one, may be an audio one, or may be both. For example, the informing portion 69 may display a predetermined image (broad concept including text) on the display.

At step ST5, the control part 5 judges whether an ending instruction of step ST13 explained above is carried out. Further, the control part 5 continues the braking and rotation at the time of negative judgment (returns to step ST2), while proceeds to step ST6 at the time of positive judgment. Note that, at step ST5, the control part 5 may judge not presence of an instruction of step ST13, but whether a previously set ending condition is satisfied. Such an ending condition, for example, may be that a predetermined time has passed from the start of the rotation.

At step ST6, the control part 5 stops the rotation of the spindle motor 43 and stops braking by the brake 39. Note that, the case where step ST6 is executed through step ST4 corresponds to a compulsory ending (abnormal ending) due to the position error being too large. Further, the time when step ST6 is executed through step ST5 corresponds to a normal ending.

At step ST14, the operator performs the work for the balance adjustment (narrow sense) based on the results of measurement shown at step ST24. For example, the male screw 55, 57, and/or 61 is attached to a suitable position.

Note that, the above procedure may be carried out in a state where the tool 101 is not attached, may be carried out in a state where the tool 101 is attached, or may be carried out in the latter state after being carried out in the former state. Further, the above procedure may be repeated until the vibration is reduced to a desired magnitude as well.

FIG. 7 is a flow chart showing details of steps ST1, ST2, and ST5 in FIG. 6 and/or variation. According to the procedure shown in this chart, for example, the brake 39 is used at the time of balance adjustment. The brake 39 is not used at times other than this. In this chart, for convenience, illustration of steps ST3, ST4, and ST6 is omitted. The control part 5 may repeatedly perform this processing in a predetermined cycle.

At step ST31, the control part 5 judges whether the operation mode of the processing machine 1 has been set (from another viewpoint, changed) by operation with respect to the operation part 67. The operation mode includes the adjustment mode for adjusting the balance about the spindle 37 and another mode (for example, a usual operation mode). Further, the control part 5 proceeds to step ST32 at the time of positive judgment and skips step ST32 at the time of negative judgment.

At step ST32, the control part 5 sets (changes in another viewpoint) the operation mode in accordance with the operation carried out at step ST31. This operation may be, for example, setting of a so-called flag or an operation similar to that in the internal portion of the computer. Further, along with the change of the operation mode, the image displayed in the informing portion 69 may change as well.

At step ST33, the control part 5 judges whether the rotation of the spindle 37 is instructed. Further, the control part 5 proceeds to step ST34 at the time of positive judgment and skips the following procedure (steps ST34 to ST37) and ends the shown processing at the time of negative judgment.

Note that when, at step ST31, the adjustment mode for adjusting the balance about the spindle 37 is set, steps ST31 to ST33 correspond to step ST1 in FIG. 6 (acceptance of the instruction of rotation for adjustment). Unlike the example shown, step ST31 and step ST33 may be integrated as well. From another viewpoint, the operation for selection of the adjustment mode and the operation for instruction of rotation may be integrated as well. For example, a switch (mechanical switch or software switch) for making the spindle 37 rotate in the adjustment mode and a switch for rotating the spindle 37 in the other mode may be separately provided, and the operation with respect to the former may correspond to the operation relating to steps ST31 and ST33. Further, step ST32 may be carried out after that, and the processing routine may proceed to step ST34.

At step ST34, the control part 5 judges whether the mode which is set at present is the adjustment mode for adjusting the balance about the spindle 37. Further, the control part 5 proceeds to step ST35 at the time of positive judgment, while proceeds to step ST36 at the time of negative judgment.

Step ST35 corresponds to step ST2 in FIG. 6. That is, at step ST35, the control part 5 operates the brake 39 and rotates the spindle motor 43.

At step ST36, the control part does not operate the brake 39, but rotates the spindle motor 43. In this case, for example, the spindle 37 is rotated for a purpose other than the balance adjustment. As such a purpose, for example, there can be mentioned warming up of the processing machine 1 or processing not according to an NC program.

At step ST37, the control part 5 judges whether a predetermined ending condition is satisfied. The ending condition may be, for example, that a predetermined operation is carried out with respect to the operation part 67 and/or that a predetermined time has passed from the start of step ST35 or ST36. Further, the control part 5, at the time of negative judgment, continues the operation of the brake 39 and rotation of the spindle 37 (step ST35) or the rotation of the spindle 37 (step ST36). Note that, for convenience of illustration, the arrow after the negative judgment is returned to the part immediately before step ST37 unlike FIG. 6. The control part 5, at the time of positive judgment, although not shown here, executes processing for stopping the operation of the brake 39 and the rotation of the spindle 37 (step ST35) or the rotation of the spindle 37 (step ST36) and then ends the shown processing.

Note that, in the case where the processing has passed through step ST35, step ST37 corresponds to step ST5 in FIG. 6. The stopping (not shown in FIG. 7) of the operation of the brake 39 and the rotation of the spindle 37 (step ST35) after that correspond to step ST6 in FIG. 6.

Steps ST31 and ST32 can be expressed as an operation for accepting setting or input of the adjustment mode on/off by the control part 5. Further, as already explained, the operations relating to steps ST31 and ST33 may be integrated. The instruction of rotation in the adjustment mode in this case may be grasped as one type of instruction for turning the adjustment mode ON.

The above explanation was given assuming steps ST11, ST31, ST33, etc. (acceptance of ON state of the adjustment mode and the like) were carried out by operation with respect to the operation part 67. However, these steps may be carried out by another method as well. For example, an instruction with respect to the control part 5 of the processing machine 1 in these steps may be an instruction from a computer connected to the control part 5 through a suitable network as well. Further, the operation for the balance adjustment may be realized by an NC program. Instruction of the steps described above (for example, instruction of the ON state of the adjustment mode and the instruction of the rotation of the spindle 37) may be included in the NC program. However, even in a case where an NC program is utilized, if the NC program is prepared by operation with respect to the operation part 67 or prepared by operation with respect to the operation part in the computer connected to the control part 5, it may be grasped that the instruction is carried out by operation with respect to the operation part.

### 5. Summary of First Embodiment

As explained above, the processing machine 1 according to the embodiment has the spindle 37, spindle drive source (spindle motor 43), moving part (for example, Y-axis moving part 31), support part (for example, Y-axis bed 29), linear motor (for example, Y-axis motor 41Y), brake 39 (for example, Y-axis brake 39Y), and control part 5. The spindle motor 43 makes the spindle 37 rotate. The Y-axis moving part 31 supports the spindle 37 and spindle motor 43. The Y-axis bed 29 supports the Y-axis moving part 31 so as to be movable in the first direction (for example, Y-direction). The Y-axis motor 41Y makes the Y-axis moving part 31 and the Y-axis bed 29 move in the Y-direction relative to each other. The Y-axis brake 39Y restricts the relative movements in the Y-direction of the Y-axis moving part 31 and the Y-axis bed 29. The control part 5 operates the Y-axis brake 39Y (steps ST2 and ST35) when adjusting the balance about the spindle 37. As one example, when the adjustment mode utilized when adjusting the balance about the spindle 37 is ON (when a positive judgment is rendered at step ST34), the control part 5 operates the Y-axis brake 39Y when rotating the spindle 37 by the spindle motor 43.

From another viewpoint, the adjustment method according to the embodiment is an adjustment method of balance in a processing machine 1. The processing machine 1 has the spindle 37, spindle drive source (spindle motor 43), moving part (for example, Y-axis moving part 31), support part (for example, Y-axis bed 29), linear motor (for example, Y-axis motor 41Y), and brake 39 (for example, Y-axis brake 39Y). The spindle motor 43 makes the spindle 37 rotate. The Y-axis moving part 31 supports the spindle 37 and spindle motor 43. The Y-axis bed 29 supports the Y-axis moving part 31 movably in the first direction (for example, Y-direction). The Y-axis motor 41Y makes the Y-axis moving part 31 and the Y-axis bed 29 move in the Y-direction relative to each other. The Y-axis brake 39Y restricts the relative movements in the Y-direction of the Y-axis moving part 31 and the Y-axis bed 29. The adjustment method has the detection step (step ST22), adjustment step (step ST14), and restriction step (steps ST2 and ST35). The detection step detects vibration about the spindle 37 in the state where the spindle 37 is rotating. The adjustment step adjusts the balance about the spindle 37 based on the vibration detected by the detection step. The restriction step restricts the relative movements in the Y-direction of the Y-axis moving part 31 and the Y-axis bed 29 by the Y-axis brake 39Y at the time when the detection step is carried out for the adjustment step.

Accordingly, for example, as explained in the explanation of the outline of the embodiment, the likelihood that the vibration would become large in the driving direction of the linear motor (for example, Y-axis motor 41Y) when the spindle 37 is rotated at a stage where the balance is not sufficiently adjusted is reduced. As a result, for example, the likelihood that the operator would be bothered by an alarm (step ST4) or the measurement of the vibration would not be carried out due to a compulsory stopping of the spindle 37 (step ST6 carried out after passing through the positive judgment a step ST3) is reduced. In an aspect where a linear motor is utilized as the driving part making the spindle 37 move parallel, for example, the position accuracy can be improved compared with an aspect where a rotary electric motor, ball screw mechanism, and coupling are utilized as the driving part, and in turn the processing accuracy can be improved. On the other hand, the spring elements which are connected to the spindle 37 are decreased, therefore vibration in the driving direction of the linear motor is apt to become large at the time of balance adjustment. When the brake 39 is operated, a spring element which is connected to the spindle 37 is added, therefore the likelihood of the vibration about the spindle 37 becoming larger is reduced. As a result, in the processing machine 1, improvement of the processing accuracy and facilitation of the balance adjustment can be both realized.

The processing machine 1 may have a hydrostatic bearing (bearing 47) which is supported upon the moving part (for example, Y-axis moving part 31) and rotatably supports the spindle 37.

In this case, for example, the frictional resistance when rotating the spindle 37 about the axis is small, therefore control of the rotation position of the spindle 37 with a high precision and high speed rotation of the spindle 37 are facilitated. On the other hand, the vibration is apt to become large due to unbalance about the spindle 37. That is, vibration is effectively reduced by the brake 39 at the time of balance adjustment. As a result, the effect of the processing machine 1 explained above of realization of both improvement of the processing accuracy and facilitation of the balance adjustment is improved.

The processing machine 1 may have a position sensor (for example, Y-axis position sensor 65Y) which detects the position in the first direction (for example, Y-direction) of the spindle 37 and the informing portion 69 which informs the user (for example, operator). When the position error of the spindle 37 based on the Y-axis position sensor 65Y exceeds a predetermined threshold value (when a positive judgment is rendered at step ST3), the control part 5 may control the informing portion 69 so as to inform that (step ST4).

Further, the processing machine 1 may have a position sensor (for example, Y-axis position sensor 65Y) which detects the position in the first direction (for example, Y-direction) of the spindle 37. When the position error of the spindle 37 based on the Y-axis position sensor 65Y exceeds a predetermined threshold value in the state where the spindle 37 is rotating (when a positive judgment is rendered at step ST3), the control part 5 may stop the rotation of the spindle 37 by the spindle drive source (spindle motor 43, step ST6 through the positive judgment at step ST3).

In these cases, as already explained, if the vibration about the spindle at the time of balance adjustment becomes large, the operator would be bothered or the measurement of vibration would no longer be able to be carried out. Accordingly, the effect by the brake 39 is effectively exerted.

The brake 39 (for example, Y-axis brake 39Y) may have the first member (for example, pads 51) and second member (for example, plate 49). The pads 51 may be supported upon the moving part (for example, Y-axis moving part 31) so as to be immovable in the first direction (for example, Y-direction) relative to the Y-axis moving part 31. The plate 49 may be supported upon the support part (for example, Y-axis bed 29) so as to be immovable in the Y-direction relative to the Y-axis bed 29. The Y-axis brake 39Y may restrict the movements in the Y-direction of the Y-axis moving part 31 and the Y-axis bed 29 by contact of the pads 51 and the plate 49.

In this case, for example, compared with an aspect where the brake 39 is a fluid brake or electric brake, the likelihood of the vibration of the spindle 37 becoming larger is easily reduced.

### Second Embodiment

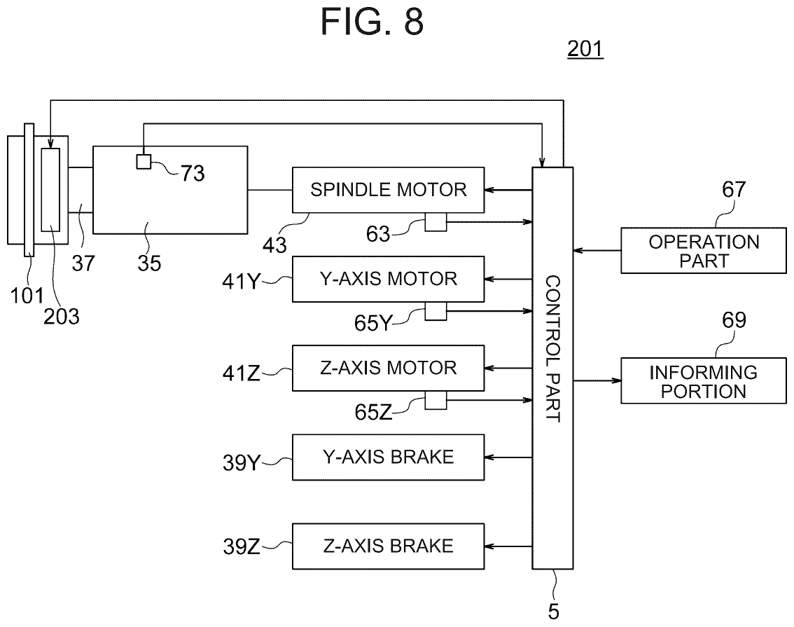

FIG. 8 is a block diagram showing the configuration of a processing machine 201 according to a second embodiment. This view corresponds to FIG. 5 for the first embodiment.

In the explanation of the second embodiment, basically only the differences from the first embodiment will be explained. The matter which is not particularly referred to may be made the same as the first embodiment or may be deduced from the explanation of the first embodiment.

The processing machine 201 is configured so as to be able to automatically adjust the balance in place of or addition to the balance adjustment manually carried out by the user. For example, the processing machine 201 has a vibration sensor 73 which measures the vibration about the spindle 37 and an adjustment part 203 which adjusts the balance about the spindle 37. The control part 5 controls the adjustment part 203 based on the detection value from the vibration sensor 73 (and the rotation sensor 63 or other sensor according to need) and adjusts the balance about the spindle 37.

The vibration sensor 73 is as explained in the first embodiment. However, in the first embodiment, as the vibration sensor 73, a detachable sensor was supposed (naturally, it need not be detachable either). On the other hand, in the present embodiment, the vibration sensor 73 need not be detachable (may be detachable).

There may be various configurations of the adjustment part 203. For example, it may be the same as a known configuration. When explaining a specific example, although not particularly shown, the adjustment part 203 has weights at a plurality of positions around the axial center of the spindle 37 and adjusts the balance by changing the positions in the diameter direction of the plurality of weights independently from each other according to the mode of operation of the electromagnet and the like.

The adjustment part 203 as described above may be provided in the spindle 37 and at any position in the member which is fixed to the spindle 37. In the example shown, an aspect where the adjustment part 203 is provided in the instrument for attaching the tool 101 to the spindle 37 is illustrated.

In such a processing machine 201, the procedure of processing executed by the control part 5, for example, may comprise part of the plurality of steps carried out by the operator and the measurement device 75 being carried out by the control part 5 in addition to the steps carried out by the control part 5 in the flow charts shown in FIG. 6 and FIG. 7.

For example, the instruction for start of step ST11 in FIG. 6 may be made the instruction of the measurement of vibration and the balance adjustment (narrow sense) based on the result of the measurement. Further, when a positive judgment is rendered at step ST1, the control part 5 proceeds to step ST2 where, in parallel to this, it may judge whether a condition of start of measurement of vibration (for example, that the rotation speed of the spindle 37 reaches the target rotation speed) is satisfied in place of the operator. Further, in the case of a positive judgment, the control part 5 may execute steps ST21 to ST23 (and ST24 according to need) in place of the measurement device 75. Here, step ST5 and step St23 may be integrated. Further, when an ending condition of the measurement is satisfied at step ST23 (step ST5), the control part 5 proceeds to step ST6 where it may stop the operation of the brake 39 and the rotation of the spindle 37. After that, the control part 5 may perform adjustment at step ST14 in place of the operator by controlling the adjustment part 203.

Further, for example, step ST33 in FIG. 7, in the same way as step ST1, may be made acceptance of an operation instructing the measurement of the vibration and the balance adjustment (narrow sense) based on the result of the measurement (or input of an NC program). As explained also in the first embodiment, steps ST31 and ST33 may be integrated as well. In the case where the steps are integrated, the operation of instructing the measurement of the vibration and the balance adjustment (narrow sense) based on the result of the measurement may be grasped as one type of the operation of instructing the ON state of the adjustment mode.

Note that, unlike the first embodiment, the balance adjustment by the adjustment part 203 may be carried out while continuing the operation of the brake 39 and the rotation of the spindle 37 as they are. Further, the measurement of vibration and the balance adjustment may be repeated while continuing the operation of the brake 39 and the rotation of the spindle 37 as they are.

In the first embodiment, depending on the operation, it is possible to rotate the spindle 37 in a state where the brake 39 is operated, even in cases other than the adjustment of balance. From another viewpoint, it cannot be identified from only the configuration of the processing machine 1 whether the measurement of vibration by the vibration sensor 73 is carried out when the spindle 37 is rotated in the adjustment mode or whether the balance adjustment (narrow sense) is carried out after the rotation in the adjustment mode. In the second embodiment, the processing machine 201 (control part 5) may be configured so that it does not use (cannot use) the brake 39 in the operation other than the balance adjustment (broad sense) as well. From another viewpoint, for example, the control part 5 may operate the brake 39 for the measurement of vibration etc. only at the time when the operation of instructing the balance adjustment by the adjustment part 203 or input of the NC program corresponding to this operation is carried out. However, the processing machine 201 may be able to use the brake 39 in the operation other than the balance adjustment as well.

As explained above, in the processing machine 201 in the present embodiment as well, when the adjustment mode utilized at the time of adjustment of the balance about the spindle 37 is the ON state (where a positive judgment is rendered at step ST34), the control part 5 operates the Y-axis brake 39Y (steps ST2 and ST35) at the time when the spindle 37 is rotated by the spindle motor 43. Accordingly, the same effects as those by the first embodiment are exerted.

The processing machine 201 may have a vibration sensor 73 which detects the vibration of the spindle 37 and an adjustment part 203 which adjusts the balance about the spindle 37. When adjusting the balance about the spindle 37 (for example, when the adjustment mode is the ON state), the control part 5 may control the adjustment part 203 based on the detection value of the vibration sensor 73 acquired in a state where the brake 39 is operating and the spindle 37 is rotating.

In this case, for example, the likelihood of occurrence of the inconvenience of the vibration becoming large before the adjustment is carried out by the adjustment part 203, the rotation of the spindle 37 being compulsorily stopped, and adjustment cannot be carried out is reduced.

### Examples and Comparative Examples

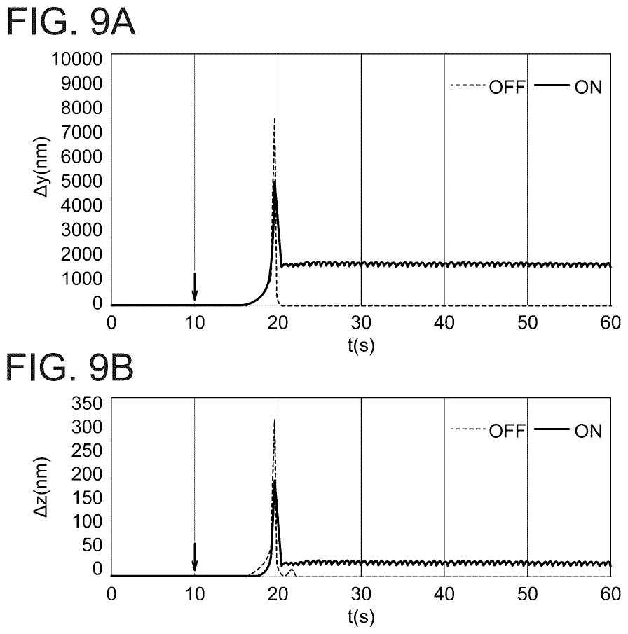

FIG. 9A and FIG. 9B are graphs showing examples of changes along with time in position error which occurs when the balance adjustment is carried out.

In these graphs, an abscissa shows the time “t” (s). An ordinate in FIG. 9A shows a position error Δy (nm) of the Y-axis moving part 31 relative to the Y-axis bed 29. The ordinate in FIG. 9B shows the position error Δz (nm) of the Z-axis moving part 33 relative to the Y-axis moving part 31.

The lines associated with “OFF” in the legend indicate the changes along with time of the position error in comparative examples. In the comparative examples, the spindle 37 is rotated without operating the Y-axis brake 39Y and Z-axis brake 39Z. On the other hand, the lines associated with “ON” in the legend indicate the changes along with time of the position error in an example. In the examples, the spindle 37 is rotated while the Y-axis brake 39Y and Z-axis brake 39Z are operated.

In each of the comparative examples and examples, at the point of time when the time “t” is 10 seconds (indicated by arrows), the rotation of the spindle 37 is started. In the comparative examples, the position error rapidly becomes large at the point of time when the time “t” is about 20 seconds. As a result, in the comparative examples, the rotation of the spindle 37 is compulsorily stopped. Due to the compulsory stopping, after the point of time when the time “t” is about 20 seconds, the position error becomes 0. On the other hand, in the examples, compared with the comparative examples, the position error at the point of time when the time “t” is about 20 seconds is reduced. As a result, no compulsory stop of the rotation of the spindle 37 is carried out.

Note that, in the above embodiments, the spindle motor 43 is one example of the spindle drive source. The combination of the Y-axis moving part 31 and the Y-axis bed 29 is one example of the moving part and support part. The combination of the Y-axis moving part 31 and the Z-axis moving part 33 is also one example of the moving part and support part. Each of the Y-direction and Z-direction is one example of the first direction. Each of the Y-axis motor 41Y and Z-axis motor 41Z is one example of the linear motor. Each of the Y-axis brake 39Y and Z-axis brake 39Z is one example of the brake. The Y-axis position sensor 65Y and Z-axis position sensor 65Z are examples of the position sensor. The pad 51 is one example of the first member. The plate 49 is one example of the second member.

The technique according to the present disclosure is not limited to the above embodiments and may be executed in various ways.

For example, in the explanation of the embodiments, as inconveniences caused by vibration being large when the spindle is rotated for the balance adjustment, alarm and compulsory stopping were explained. However, the alarm and the compulsory stopping being carried out are not indispensable factors in the processing machine according to the present disclosure. From another viewpoint, the effect of solving the inconveniences may not be exerted either. Note that, if the vibration when rotating the spindle for the measurement of the vibration contributing to the balance adjustment is reduced, for example, a necessity of performing the balance adjustment (narrow sense) in advance before performing the measurement of vibration is reduced, therefore the load of the operator or control part is lightened. Further, for example, the likelihood of a structural load (weight) being applied to the processing machine due to large vibration which is not predicted is reduced.

In the first and second embodiments, the brake 39 operated when the adjustment mode was ON. However, such a mode need not be prepared. The brake 39 may operate at the time of balance adjustment by the brake 39 and the spindle motor 43 being individually operated. For example, the operation part 67 may be separately provided with the switch (mechanical switch or software switch) for controlling the brake 39 and with the switch for controlling the spindle motor 43. Further, the operator may operate the brake 39 by the operation with respect to the former and then rotate the spindle motor 43 by operation with respect to the latter. Further, as already explained, an NC program may be used as well. In this case, the NC program may include a code for operating the brake and a code for rotating the spindle.

### REFERENCE SIGNS LIST

1 . . . processing machine, 3 . . . machine body, 5 . . . control part, 25 . . . table, 37 . . . spindle, 41Y . . . Y-axis motor (linear motor), 41Z . . . Z-axis motor (linear motor), 43 . . . spindle motor (spindle drive source), 29 . . . Y-axis bed (support part for Y-axis moving part), 31 . . . Y-axis moving part (moving part for Y-axis bed, support part for Z-axis moving part), 33 . . . Z-axis moving part (moving part for Y-axis moving part), 39 . . . brake, 39Y . . . Y-axis brake (brake), 39Z . . . Z-axis brake (brake), 101 . . . tool, and 103 . . . workpiece.

1. A processing machine comprising:
a spindle;
a spindle drive source configured to rotate the spindle;
a moving part which supports the spindle and the spindle drive source;
a support part which supports the moving part so as to be movable in a first direction;
a linear motor configured to make the moving part and the support part move in the first direction relative to each other;
a brake configured to restrict relative movement in the first direction of the moving part and the support part; and
a control part configured to operate the brake when adjusting a balance about the spindle.

2. The processing machine according to claim 1, comprising a hydrostatic bearing which is supported by the moving part and rotatably supports the spindle.

3. The processing machine according to claim 1, comprising:
a position sensor configured to detect a position in the first direction of the spindle; and
an informing portion configured to present information to a user, wherein in response to a position error of the spindle based on the position sensor exceeding a predetermined threshold value, the control part is configured to control the informing portion to display position error information.

4. The processing machine according to claim 1, comprising a position sensor configured to detect a position in the first direction of the spindle, wherein the control part is configured to control the spindle drive source so as to stop rotation of the spindle in response to a position error of the spindle based on the position sensor exceeding a predetermined threshold value in a state where the spindle is rotating.

5. The processing machine according to claim 1, wherein;
the brake comprises:
a first member which is supported by the moving part so as to be immovable in the first direction relative to the moving part, and
a second member which is supported by the support part so as to be immovable in the first direction relative to the support part; and
the brake is configured to restrict the movements in the first direction of the moving part and the support part by contact of the first member and the second member.

6. The processing machine according to claim 1, comprising:
a vibration sensor configured to detect vibration about the spindle; and
an adjustment part configured to adjust a balance about the spindle, wherein
when adjusting the balance about the spindle, the control part is configured to control the adjustment part based on a detection value of the vibration sensor which is acquired in a state where the brake is operating and the spindle is rotating.

7. The processing machine according to claim 1, wherein the control part is configured to operate the brake when rotating the spindle by the spindle drive source when an adjustment mode utilized when adjusting the balance about the spindle is in an ON state.

8. An adjustment method of balance in a processing machine, wherein the processing machine comprises:
a spindle
a spindle drive source configured to rotate the spindle,
a moving part which supports the spindle and the spindle drive source,
a support part which supports the moving part so as to be movable in a first direction,
a linear motor configured to make the moving part and the support part move in the first direction relative to each other, and
a brake configured to restrict relative movement in the first direction of the moving part and the support part,
the adjustment method comprising:
detecting a vibration about the spindle in a state where the spindle is rotating;
adjusting the balance about the spindle based on the vibration detected according to the detecting; and
restricting the relative movement in the first direction of the moving part and the support part according to the brake when the detecting is performed.
